(19) United States
(12) Patent Application Publication
(10) Pub. No.: US 2025/0203529 A1
(43) Pub. Date: Jun. 19, 2025

(54) METHODS AND APPARATUSES FOR IMPLEMENTING SIDELINK TRANSMISSION POWER LIMITATION

(71) Applicant: Lenovo (Beijing) Limited, Beijing (CN)

(72) Inventors: Zhennian Sun, Beijing (CN); Xiaodong Yu, Beijing (CN); Haipeng Lei, Beijing (CN); Xin Guo, Beijing (CN)

(73) Assignee: Lenovo (Beijing) Limited, Beijing (CN)

(21) Appl. No.: 18/845,467

(22) PCT Filed: Mar. 11, 2022
(86) PCT No.: PCT/CN2022/080422

§ 371 Date: Sep. 10, 2024

(51) Int. Cl. H04W 52/34; H04L 1/1812; H04W 72/25

(52) U.S. Cl. CPC H04W 52/34; H04L 1/1812; H04W 72/25

(57) ABSTRACT

Disclosed are methods and apparatuses for user equipment (UE) transmission power control. An embodiment of the subject application provides a UE including: a processor; and a wireless transceiver coupled to the processor, wherein the processor is configured to, in response to that total SL transmission power of a first set of sidelink (SL) transmissions is above a maximum transmission power: determine evaluation priorities for the first set of SL transmissions; evaluate at least one SL transmission of the first set of SL transmissions in order according to the determined evaluation priorities and the maximum transmission power to determine whether to add the at least one SL transmission to a second set of SL transmissions; and transmit, with the wireless transceiver, the second set of SL transmissions, wherein the second set of SL transmissions can be performed on sub-carriers with different subcarrier spacings.

### TECHNICAL FIELD

The present disclosure generally relates to wireless communications and especially relates to implementing sidelink (SL) transmission power limitation.

### BACKGROUND OF THE INVENTION

Carrier aggregation (CA) technology can aggregate multiple component carriers (CCs) together to achieve a wider transmission bandwidth up to e.g., 100 MHz, which will effectively improve the uplink (UL) and downlink (DL) transmission rates.

Long Term Evolution (LTE) SL supports CA with single subcarrier spacing (15 kHz), and none physical SL feedback channel (PSFCH) channel is used in LTE SL CA. NR SL supports one single carrier and transmissions of PSFCH for SL hybrid automatic repeat request (HARQ) and PSFCH for resource conflict indicator. When SL CA is supported for NR SL, different SCSs (i.e., subcarrier spacings) can be configured, and PSFCH can be also configured for one or more CCs.

In LTE SL CA, if a user equipment (UE) would transmit multiple physical sidelink shared channels (PSSCHs) on multiple CCs, and the PSSCHs are overlapping in time domain, the UE needs to make sure that a total transmitting power should not exceed a maximum transmitting power. If a total transmitting power exceeds a maximum transmitting power, the UE adjusts the transmitting power of PSSCHs e.g., according to the transmission priority; if the transmitting power still exceeds the maximum transmitting power after the adjustment, the UE may drops the PSSCHs with low priorities.

### SUMMARY

The present disclosure provides various methods and apparatuses related to implementing SL transmission power limitation.

Some embodiments of the present disclosure provide a UE including: a processor; and a wireless transceiver coupled to the processor, wherein the processor is configured to: determine evaluation priorities for the first set of SL transmissions; evaluate at least one SL transmission of the first set of SL transmissions in order according to the determined evaluation priorities and the maximum transmission power to determine whether to add the at least one SL transmission to a second set of SL transmissions; and transmit, with the wireless transceiver, the second set of SL transmissions, wherein the second set of SL transmissions can be performed on sub-carriers with different subcarrier spacings.

In some embodiments, the determination of the evaluation priorities for the first set of SL transmissions is performed based partly on at least one of the following: a transmission priority, an SL channel type, or transmission power associated with each SL transmission of the first set of SL transmissions.

In some embodiments, an SL channel type for each SL transmission of the first set of SL transmissions is PSFCH for HARQ feedback, physical SL shared channel (PSSCH), or PSFCH for resource conflict indicator.

In some embodiments, to determine the evaluation priorities, the processor is configured to determine that, among the first set of SL transmissions, an evaluation priority of an SL transmission having a higher transmission priority is higher than that of another SL transmission having a lower transmission priority.

In some embodiments, to determine the evaluation priorities, in response to that among the first set of SL transmissions, both a first SL transmission carried by a PSFCH for HARQ feedback and a second SL transmission carried by a PSSCH have the same transmission priority, the processor is further configured to determine that an evaluation priority of the first SL transmission is higher than that of the second SL transmission.

In some embodiments, to determine the evaluation priorities, in response to that among the first set of SL transmissions, both a first SL transmission carried by a PSSCH and a second SL transmission carried by a PSFCH for resource conflict indicator have the same transmission priority, the processor is further configured to determine that an evaluation priority of the first SL transmission is higher than that of the second SL transmission.

In some embodiments, to determine the evaluation priorities, in response to that among the first set of SL transmissions, both a first SL transmission carried by a PSSCH and a second SL transmission carried by a PSFCH for resource conflict indicator have the same transmission priority, the processor is further configured to determine that the first SL transmission and the second SL transmission have the same evaluation priority.

In some embodiments, to determine the evaluation priorities, in response to that among the first set of SL transmissions, both a first SL transmission carried by a PSFCH either for HARQ feedback or for resource conflict indicator and a second SL transmission carried by a PSSCH have the same transmission priority, the processor is further configured to determine that an evaluation priority of the first SL transmission is higher than that of the second SL transmission.

In some embodiments, the determination of the evaluation priorities of the first set of SL transmissions is performed based on at least the SL channel type of each SL transmission of the first set of SL transmissions.

In some embodiments, the processor is configured to determine that among the first set of SL transmissions, an evaluation priority of a first SL transmission carried by a PSFCH for HARQ feedback is higher than that of a second SL transmission carried by a PSSCH.

In some embodiments, the processor is configured to determine that among the first set of SL transmissions, an evaluation priority of a first SL transmission carried by a PSSCH is higher than that of a second SL transmission carried by a PSFCH for resource conflict indicator.

In some embodiments, to determine the evaluation priorities, the processor is configured to determine that among the first set of SL transmissions, an evaluation priority of a first SL transmission which has a higher transmission priority and is carried by a PSSCH or a PSFCH for resource conflict indicator is higher than that of a second SL transmission which has a lower transmission priority and is carried by a PSSCH or a PSFCH for resource conflict indicator.

In some embodiments, to determine the evaluation priorities, the processor is configured to determine that among the first set of SL transmissions, a first SL transmission carried by a PSFCH for resource conflict indicator or by PSFCH for HARQ feedback has a higher evaluation priority as that of a second SL transmission carried by a PSSCH.

In some embodiments, to determine the evaluation priorities, in response to that among the first set of SL transmissions, both a first SL transmission and a second SL transmission have the same transmission priority and are carried by PSSCHs, and the first SL transmission occupies a shorter duration than that of the second SL transmission, the processor is configured to determine that an evaluation priority of the first SL transmission is higher than that of the second SL transmission.

In some embodiments, to determine the evaluation priorities, in response to that among the first set of SL transmissions, both a first SL transmission and a second SL transmission have the same transmission priority and are carried by PSSCHs, and the first SL transmission has less transmission power that that of the second SL transmission, the processor is configured to determine that the first SL transmission has a higher evaluation priority than that of the second SL transmission.

In some embodiments, to determine the evaluation priorities, in response to that among the first set of SL transmissions, both a first SL transmission and a second SL transmission have the same transmission priority and are carried by PSFCHs for HARQ feedback, and the first SL transmission has less transmission power that that of the second SL transmission, the processor is configured to determine that the first SL transmission has a higher evaluation priority than that of the second SL transmission.

In some embodiments, to evaluate at least one SL transmission of the first set of SL transmissions in order, the processor is configured to: select an SL transmission among the first set of SL transmissions in order according to the determined evaluation priorities of the first set of SL transmissions; in response to total transmission power of the selected SL transmission and the second set of SL transmissions being less than or equal to the maximum transmission power, add the selected SL transmission to the second set of SL transmissions.

In some embodiments, in response to total transmission power of the selected SL transmission and the second set of SL transmissions is greater than the maximum transmission power and the selected SL transmission is carried by an SL channel other than a PSSCH, the processor is further configured to stop the evaluation associated with the maximum transmission power.

In some embodiments, in response to that total transmission power of the selected SL transmission and the second set of SL transmissions is greater than the maximum transmission power and the selected SL transmission is carried by a PSSCH: adjust transmission power of the selected SL transmission; and in response to that total transmission power of the adjusted transmission power of the selected SL transmission and transmission power of the second set of SL transmissions is less than or equates to the maximum transmission power, add the selected SL transmission to the second set of SL transmissions.

In some embodiments, in response to that total transmission power of the adjusted transmission power of the selected SL transmission and the transmission power of the second set of SL transmissions is greater than the maximum transmission power stop the evaluation associated with the maximum transmission power.

Some embodiments of the present disclosure provide a method performed by a UE. The method includes in response to that total SL transmission power of a first set of SL transmissions is above a maximum transmission power: determining evaluation priorities for the first set of SL transmissions; evaluating at least one SL transmission of the first set of SL transmissions in order according to the determined evaluation priorities and the maximum transmission power, so as to determine whether to add the at least one SL transmission to a second set of SL transmissions;

in and transmitting the second set of SL transmissions, wherein the second set of SL transmissions can be performed on sub-carriers with different subcarrier spacings.

In some embodiments, the determination of the evaluation priorities for the first set of SL transmissions is performed based partly on at least one of the following: a transmission priority, an SL channel type, or transmission power associated with each SL transmission of the first set of SL transmissions.

In some embodiments, an SL channel type for each SL transmission of the first set of SL transmissions is PSFCH for HARQ feedback, PSSCH, or PSFCH for resource conflict indicator.

In some embodiments, the determination of the evaluation priorities further includes determining that, among the first set of SL transmissions, an evaluation priority of an SL transmission having a higher transmission priority is higher than that of another SL transmission having a lower transmission priority.

In some embodiments, in response to that among the first set of SL transmissions, both a first SL transmission carried by a PSFCH for HARQ feedback and a second SL transmission carried by a PSSCH have the same transmission priority, the determination of the evaluation priorities further includes determining that an evaluation priority of the first SL transmission is higher than that of the second SL transmission.

In some embodiments, in response to that among the first set of SL transmissions, both a first SL transmission carried by a PSSCH and a second SL transmission carried by a PSFCH for resource conflict indicator have the same transmission priority, the determination of the evaluation priorities further includes determining that an evaluation priority of the first SL transmission is higher than that of the second SL transmission.

In some embodiments, in response to that among the first set of SL transmissions, both a first SL transmission carried by a PSSCH and a second SL transmission carried by a PSFCH for resource conflict indicator have the same transmission priority, the determination of the evaluation priorities further includes determining that the first SL transmission and the second SL transmission have the same evaluation priority.

In some embodiments, in response to that among the first set of SL transmissions, both a first SL transmission carried by a PSFCH either for HARQ feedback or for resource conflict indicator and a second SL transmission carried by a PSSCH have the same transmission priority, the determination of the evaluation priorities further includes determining that an evaluation priority of the first SL transmission is higher than that of the second SL transmission.

In some embodiments, the determination of the evaluation priorities of the first set of SL transmissions is performed based on at least the SL channel type of each SL transmission of the first set of SL transmissions.

In some embodiments, the determination of the evaluation priorities further includes determining that among the first set of SL transmissions, an evaluation priority of a first SL transmission carried by a PSFCH for HARQ feedback is higher than that of a second SL transmission carried by a PSSCH.

In some embodiments, the determination of the evaluation priorities further includes determining that an evaluation priority of a first SL transmission carried by a PSSCH is higher than that of a second SL transmission carried by a PSFCH for resource conflict indicator.

In some embodiments, the determination of the evaluation priorities further includes determining that, among the first set of SL transmissions, an evaluation priority of a first SL transmission which has a higher transmission priority and is carried by a PSSCH or a PSFCH for resource conflict indicator is higher than that of a second SL transmission which has a lower transmission priority and is carried by a PSSCH or a PSFCH for resource conflict indicator.

In some embodiments, the determination of the evaluation priorities further includes determining that among the first set of SL transmissions, a first SL transmission carried by a PSFCH for resource conflict indicator or by PSFCH for HARQ feedback has a higher evaluation priority as that of a second SL transmission carried by a PSSCH.

In some embodiments, in response to that among the first set of SL transmissions, both a first SL transmission and a second SL transmission have the same transmission priority and are carried by PSSCHs, and the first SL transmission occupies a shorter duration than that of the second SL transmission, the determination of the evaluation priorities further includes determining that an evaluation priority of the first SL transmission is higher than that of the second SL transmission.

In some embodiments, in response to that among the first set of SL transmissions, both a first SL transmission and a second SL transmission have the same transmission priority and are carried by PSSCHs, and the first SL transmission has less transmission power that that of the second SL transmission, the determination of the evaluation priorities further includes determining that the first SL transmission has a higher evaluation priority than that of the second SL transmission.

In some embodiments, in response to that among the first set of SL transmissions, both a first SL transmission and a second SL transmission have the same transmission priority and are carried by PSFCHs for HARQ feedback, and the first SL transmission has less transmission power that that of the second SL transmission, the determination of the evaluation priorities further includes determining that the first SL transmission has a higher evaluation priority than that of the second SL transmission.

In some embodiments, the evaluation of at least one SL transmission of the first set of SL transmissions in order further includes: selecting an SL transmission among the first set of SL transmissions in order according to the determined evaluation priorities of the first set of SL transmissions; in response to total transmission power of the selected SL transmission and the second set of SL transmissions being less than or equal to the maximum transmission power, adding the selected SL transmission to the second set of SL transmissions.

In some embodiments, in response to total transmission power of the selected SL transmission and the second set of SL transmissions is greater than the maximum transmission power and the selected SL transmission is carried by an SL channel other than a PSSCH, the evaluation further includes stopping the evaluation associated with the maximum transmission power.

In some embodiments, in response to that total transmission power of the selected SL transmission and the second set of SL transmissions is greater than the maximum transmission power and the selected SL transmission is carried by a PSSCH, the evaluation further includes: adjusting transmission power of the selected SL transmission; and in response to that total transmission power of the adjusted transmission power of the selected SL transmission and transmission power of the second set of SL transmissions is less than or equates to the maximum transmission power, adding the selected SL transmission to the second set of SL transmissions.

In some embodiments, in response to that total transmission power of the adjusted transmission power of the selected SL transmission and the transmission power of the second set of SL transmissions is greater than the maximum transmission power, the evaluation further includes stopping the evaluation associated with the maximum transmission power.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary scenario according to some embodiments of the present disclosure.

FIG. 2 illustrates an exemplary method performed by a UE according to some embodiments of the present disclosure.

FIG. 3 illustrates an exemplary occasion according to some embodiments of the present disclosure.

FIG. 4 illustrates an exemplary flow chart according to some embodiments of the present disclosure.

FIG. 5 illustrates an exemplary occasion according to some embodiments of the present disclosure.

FIG. 6 illustrates an exemplary occasion according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

As aforementioned, LTE SL CA supports single subcarrier spacing (15 KHz), without using PSFCH channels. In LTE SL CA, a UE may transmit multiple PSSCHs on CCs with the same subcarrier spacing; in the case that a total transmitting power exceeds a maximum transmitting power, the UE may adjust the transmission power of the PSSCHs according to their transmission priority. If the total transmission power still exceeds the maximum transmitting power after the adjustment, the UE may drop the PSSCHs with lowest priorities.

However, this simple power adjustment method or PSSCH dropping method is not suitable for NR SL CA. This is because that in an NR SL CA scenario, different CC spacings may be used; therefore, some SL transmissions may overlap with each other; furthermore, in an NR SL CA scenario, PSFCHs for HARQ feedback and PSFCHs for resource conflict indicator may be used; furthermore, in some cases, the UE cannot predict the total transmission power accurately due to that for example, the transmission of a PSFCH is depended upon the reception from other UEs, when a UE receives unpredicted information from other UEs during SL communication, it may transmit an associated PSFCH several slots late. Therefore, an NR SL CA scenario is more complex than an LTE SL CA.

FIG. 1 illustrates an exemplary NR SL CA scenario: there are two CCs used, CC1 has a subcarrier spacing of 15 kHz, CC2 has a subcarrier spacing of 30 kHz, herein AGC is automatic gain control.

As shown in the FIG. 1, in occasion 100, a UE would transmit PSSCH #1 with CC1, and would transmit PSSCH #2 and PSSCH #3 with CC2; hereinafter, an occasion is one SL slot which is determined by the minimum subcarrier spacing among the multiple carriers; in this example, occasion 100 is determined by CC1.

According to some embodiments of the present disclosure, in e.g., an NR SL CA scenario, an occasion is divided into multiple portions depending on the transmission power varying; in a portion, the SL transmission power does not change. In this example, occasion 100 is divided into two portions: portion1 and portion2. In an NR SL CA scenario, as different subcarrier spacings are supported, an SL transmission may partially overlap with another SL transmission. In this example, PSSCH #1 and PSSCH #2 partially overlap in portion1, PSSCH #1 and PSSCH #3 partially overlap in portion2. In this example, PSSCH #1 has a transmission priority value 4, PSSCH #2 has a transmission priority value 6, PSSCH #3 has a transmission priority value 1; hereinafter, the higher the transmission priority value, the lower the transmission priority. In this example, the total transmission power within portion1 is 1.3P_{CMAX}; the total transmission power within portion2 is 1.1P_{CMAX}; it can be seen that the total transmission power in each portion exceeds the maximum transmission power (represented by P_{CMAX}).

If following LTE SL CA solution to guarantee that the total transmission power of first portion doesn't exceed the maximum transmission power in this example, PSSCH #2 should be dropped due to it has a lower transmission priority than PSSCH #1; to guarantee that the total transmission power of second portion doesn't exceed the maximum transmission power, PSSCH #1 should be dropped due to that it has a lower transmission priority than PSSCH #3; therefore, only PSSCH #3 will be transmitted. However, if PSSCH #1 is dropped, both PSSCH #2 and PSSCH #3 can be transmitted under the restriction of maximum transmission power. It can be seen that, if following LTE SL CA solution to guarantee a total transmission power of a portion not to exceed a maximum transmission power, the transmission power may be wasted and more SL transmission may be dropped than needed. Therefore, a suitable solution for NR SL CA scenarios needs to be considered.

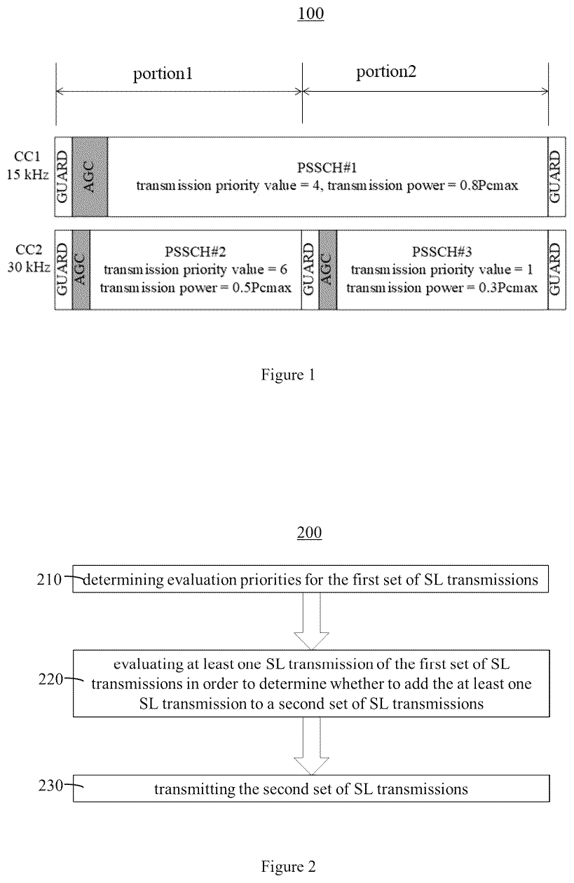

FIG. 2 illustrates an exemplary method 200 performed by a UE according to some embodiments of the present disclosure. Hereinafter, the UE may refer to be as an SL UE supporting NR SL CA or a UE may use the technology described in the present disclosure.

According to some embodiments of the present disclosure, method 200 may be performed in response to that total SL transmission power of a first set of sidelink (SL) transmissions is above a maximum transmission power.

According to some embodiments of the present disclosure, method 200 may be performed in response to that total SL transmission power of a first set of sidelink (SL) transmissions in an occasion or in a portion of an occasion is above a maximum transmission power. Herein, an occasion is one SL slot which is determined by the minimum subcarrier spacing among the multiple subcarrier spacings; for example, if the minimum subcarrier spacing is 15 kHz, then the corresponding occasion is 1 ms; an occasion is divided into multiple portions depending upon the transmission power varying; in a portion, the SL transmission power does not change.

As illustrated in FIG. 2, method 200 includes operation 210, operation 220, and operation 230. In operation 210, the UE determines an evaluation priority for each of the first set of SL transmissions. In some embodiments, the first set of SL transmissions is SL transmissions on carriers (i.e., CCs) that may have different subcarrier spacings.

In operation 220, the UE evaluate at least one SL transmission of the first set of SL transmissions in order according to at least the determined evaluation priorities (from highest evaluation priority to lowest evaluation priority) and the maximum transmission power to determine whether to add the at least one SL transmission to a second set of SL transmissions; herein the second set of SL transmissions consists of at least one SL transmission of the first set of SL transmissions and can be performed on CCs with different subcarrier spacings.

In operation 230, the UE transmits the second set of SL transmissions.

In some embodiments, method 200 further includes dividing an occasion into multiple portions according to the transmission power varying. In each portion, the transmission power does not change.

In some embodiments, in operation 210, the UE determines evaluation priorities for the first set of SL transmissions based partly on at least one of the followings: a transmission priority, an SL channel type, or transmission power associated with each SL transmission of the first set of SL transmissions. In some embodiments, a transmission duration associated with at least one SL transmission of the first set of SL transmissions is also considered.

In some embodiments, an SL channel type for each SL transmission of the first set of SL transmissions is PSFCH for HARQ feedback, PSSCH, or PSFCH for resource conflict indicator. As the NR SL technology is being developed time to time, more types of channels may be supported according to the spirit of the present disclosure in the further.

In some embodiments, in operation 210, the UE determines that within the first set of SL transmissions, an SL transmission having a higher transmission priority has a higher evaluation priority that an SL transmission having a lower transmission priority, regardless of the SL channel types of these two SL transmissions. In some embodiments, the higher the transmission priority value, the lower the transmission priority, and the lower the evaluation priority.

For example, the UE may determine that an SL transmission carried by a PSSCH and having a transmission priority value 2 has a higher evaluation priority than that of an SL transmission carried by a PSFCH for HARQ feedback and having a transmission priority value 3.

For example, the UE may determine that an SL transmission carried by a PSFCH for resource conflict indicator and having a transmission priority value 1 has a higher evaluation priority than an SL transmission carried by a PSFCH for HARQ feedback and having a transmission priority value 3.

For example, the UE may determine that an SL transmission carried by a PSFCH for HARQ and having a transmission priority value 3 has a higher evaluation priority than an SL transmission carried by a PSSCH and having a transmission priority value 5.

In some embodiments, in operation 210, if two SL transmissions of the first set of SL transmissions have the same transmission priority, the UE may determine their evaluation priorities further according to their corresponding SL channel types.

For example in operation 210, if a first SL transmission carried by a PSFCH for HARQ feedback and a second SL transmission carried by a PSSCH have the same transmission priority, the UE may determine that an evaluation priority of the first SL transmission is higher than that of the second SL transmission.

For example in operation 210, if a first SL transmission carried by a PSSCH and a second SL transmission carried by a PSFCH for resource conflict indicator have the same transmission priority, the UE may determine that an evaluation priority of the first SL transmission is higher than that of the second SL transmission.

In some embodiments, in operation 210, if a first SL transmission carried by a PSSCH and a second SL transmission carried by a PSFCH for resource conflict indicator have the same transmission priority, the UE may determine that the first SL transmission and the second SL transmission have the same evaluation priority.

In some embodiments, in operation 210, if a first SL transmission carried by a PSSCH and a second SL transmission carried by a PSFCH for resource conflict indicator have the same transmission priority, the UE may determine their evaluation priorities further according to their transmission power and/or their transmission duration; in some embodiments, the UE may determine that the one of them having a less transmission power has a higher evaluation priority; in some embodiments, the UE may determine that the one of them has a shorter transmission duration has a higher evaluation priority.

In some embodiments, if a first SL transmission carried by a PSFCH either for HARQ feedback or for resource conflict indicator and a second SL transmission carried by a PSSCH have the same transmission priority, the UE determines that the first SL transmission has a higher evaluation priority than that of the second SL transmission.

In some embodiments, in operation 210, the UE determines the evaluation priorities of the first set of SL transmissions partly based on at least an SL channel type of each SL transmission of the first set of SL transmissions.

For example, in operation 210, the UE may determine that an evaluation priority of a first SL transmission carried by a PSFCH for HARQ feedback is always higher than that of a second SL transmission carried by a PSSCH, regardless of their transmission priorities.

For example, in operation 210, the UE may determine that within the first set of SL transmissions, an evaluation priority of a first SL transmission carried by a PSSCH is always higher than that of a second SL transmission carried by a PSFCH for resource conflict indicator, regardless of their transmission priorities.

For example, in operation 210, if each of a first SL transmission and a second SL transmission is carried by either a PSSCH or a PSFCH for resource conflict indicator; the UE may determine their evaluation priorities according to their transmission priorities, and/or their transmission power, and/or their transmission duration. In some embodiments, the UE may determine that an evaluation priority of a first SL transmission which has a higher transmission priority and is carried by either a PSSCH or a PSFCH for resource conflict indicator is higher than that of a second SL transmission which has a lower transmission priority and is carried by either a PSSCH or a PSFCH for resource conflict indicator.

For example, in operation 210, the UE may determine that within the first set of SL transmissions, a first SL transmission carried by either a PSFCH for resource conflict indicator or a PSFCH for HARQ feedback always has a higher evaluation priority as that of a second SL transmission carried by a PSSCH.

In some embodiments, in operation 210, if an SL channel carrying a first SL transmission and an SL channel carrying a second SL transmission are of the same channel type, the UE may determine their evaluation priorities based on at least their transmission priorities and/or their transmission power and/or their transmission duration.

For example, in operation 210, for the same SL channel type, the UE determines that an SL transmission having a higher transmission priority has a higher evaluation priority that an SL transmission having a lower transmission priority.

In some embodiments, in operation 210, if a first SL transmission and a second SL transmission are carried by SL channels of the same channel type and have the same transmission priority, the UE may determine their evaluation priorities based on at least their transmission power and/or their transmission duration.

For example, in operation 210, both a first SL transmission and a second SL transmission have the same transmission priority and are carried by PSSCHs, the UE may determine that the first SL transmission occupying a shorter duration has a higher evaluation priority than that of the second SL transmission occupying a loner duration.

For example, in operation 210, both a first SL transmission and a second SL transmission have the same transmission priority and are carried by PSSCHs, the UE may determine that the first SL transmission having less transmission power has a higher evaluation priority than that of the second SL transmission having greater transmission power.

For example, in operation 210, both a first SL transmission and a second SL transmission have the same transmission priority and are carried by PSFCHs for HARQ feedback, the UE may determine that the first SL transmission having less transmission power has a higher evaluation priority than that of the second SL transmission having greater transmission power.

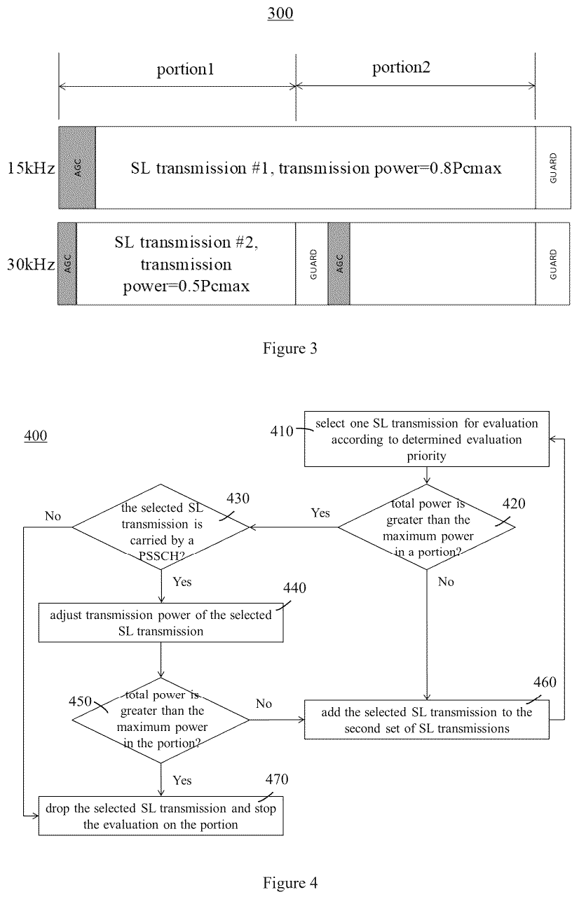

FIG. 3 illustrates an exemplary NR SL CA occasion 300 where two SL transmissions (SL transmission #1 and SL transmission #2) are carried by the same type of channels (i.e., PSSCHs) on two CCs respectively and have the same transmission priority; herein SL transmission #2 occupies a shorter duration and has less transmission power (0.5P_{CMAX}); one CC has a subcarrier spacing 15 kHz, and another CC has a subcarrier spacing 30 kHz; the two SL transmission #1 occupies a longer duration and has greater transmission power (0.8P_{CMAX}). During portion1 of occasion 300, the total transmission power is 1.3P_{CMAX}; duration portion2 of occasion 300, the total transmission power is 0.8P_{CMAX}. It can be seen that the total transmission power in portion1 exceeds the maximum transmission power 1.0P_{CMAX}. Accordingly, the UE needs to implement maximum transmission power limitation.

According to some embodiments of operation 210 of method 200, since the transmission power of SL transmission #2 is 0.5P_{CMAX}, which is less that the transmission power of SL transmission #1, the UE may determine SL transmission #2 has a higher evaluation priority than that of SL transmission #1.

According to some embodiments of operation 210 of method 200, since the transmission duration of SL transmission #2 is shorter than that of SL transmission #1, the UE may determine SL transmission #2 has a higher evaluation priority than that of SL transmission #1.

According to some embodiments of method 200, after the UE determines the evaluation priority of each of the first set of SL transmissions, the UE may evaluate at least one SL transmission of the first set of SL transmissions according to the determined evaluation priorities. In other words, the UE may sequentially evaluate at least one SL transmission of the first set of SL transmissions in order from high evaluation priority to low evaluation priority according to the determined evaluation priority, to determine whether to add the at least one SL transmission to a second set of SL transmissions. In some embodiments, before perform operation 220, the second set of SL transmission is null, and total transmission power of the second set of SL transmissions is zero.

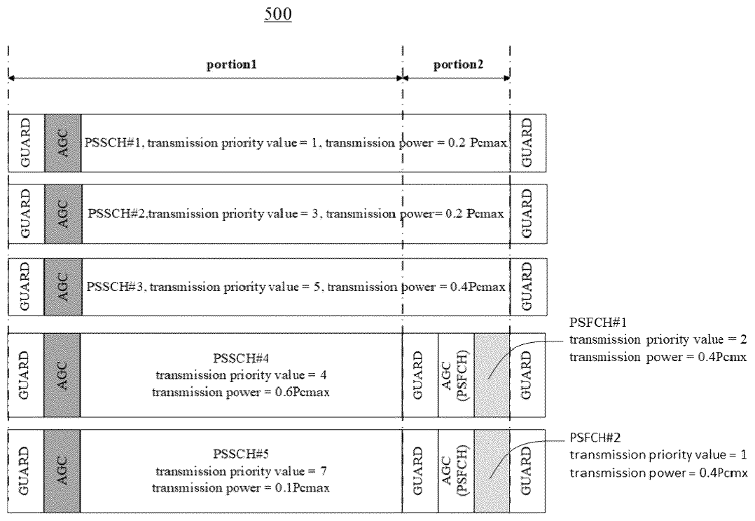

FIG. 4 illustrates an exemplary flow chart 400 according to some embodiments of operation 220 of method 200 of the present disclosure.

In step 410, the UE selects an SL transmission within the first set of SL transmissions in order from high evaluation priority to low evaluation priority; the SL transmission is selected for evaluation whether to be added to the second set of SL transmissions. Then the UE performs step 420 for the selected SL transmission.

In step 420, the UE determines whether the total transmission power of the selected SL transmission and the second set of SL transmission is greater than the maximum transmission power in a portion. If the conclusion is “No,” the UE performs step 460, i.e., the UE adds the selected SL transmission to the second set of SL transmissions. If the conclusion is “Yes,” the UE performs step 430.

In step 430, the UE determines whether the selected SL transmission is carried by a PSSCH. If the conclusion is “No,” the UE performs step 470. If the conclusion is “Yes,” the UE performs step 440; i.e., the UE adjusts transmission power of the selected SL transmission, and then the UE performs step 450.

In step 450, the UE determines whether the total transmission power of the adjusted transmission power of the selected SL transmission and the transmission power of the second set of SL transmission in the portion is greater than the maximum transmission power. If the conclusion is “No,” the UE performs step 460, i.e., the UE adds the selected SL transmission to the second set of SL transmissions. If the conclusion is “Yes,” the UE performs step 470.

In step 460, after the selected SL transmission is added to the second set of SL transmissions, and there is other SL transmission(s) within the first set of SL transmissions that is not ever selected in step 410, the UE continues to perform step 410 to select one SL transmission according to the determined evaluation priority from higher evaluation priority to lower evaluation priority. In step 460, if all the SL transmissions within the first set of SL transmissions are processed (dropped or added to the second set of SL transmissions), the UE leaves flow chart 400 and perform operation 230 if the second set of SL transmissions includes at least one SL transmission.

In step 470, the UE drops the selected SL transmission and stops the evaluation on the portion; if there are other SL transmissions within the first set of SL transmissions which (partly) occupy the portion and are not selected in step 410, the UE drops all these SL transmissions also. In step 470, if there are SL transmissions within the first set of SL transmissions which does not occupy the portion and are not selected in step 410, the UE performs step 410 again; otherwise, the UE leaves flow chart 400; the UE further performs operation 230 if the second set of SL transmissions includes at least one SL transmission.

An exemplary processing according to some embodiments of method 200 will be described below in conjunction with an exemplary occasion 500 illustrated in FIG. 5 by referring to exemplary flow chart 400 illustrated in FIG. 4. In occasion 500, the UE would transmit a first set of SL transmissions {PSSCH #1, PSSCH #2, PSSCH #3, PSSCH #4, PSSCH #5, PSFCH #1, PSFCH #2}; herein a PSFCH may be a PSFCH for HARQ feedback or PSFCH for resource conflict indicator. In this example, each SL transmission has an associated transmission priority; the higher the transmission priority value, the lower the transmission priority.

In this example, occasion 500 is divided into two portions (portion 1 and portion 2) depended upon the transmission power varying. The maximum transmission power is represented by P_{CMAX}. The total transmission power during portion 1 and the total transmission power during portion 2 are 1.5P_{CMAX} and 1.6P_{CMAX} respectively; they both exceed the maximum transmitting power P_{CMAX}. According to some embodiments of the present disclosure, the UE needs to perform method 200 to implement maximum transmission power limitation.

In operation 210, assuming the higher the transmission priority, the higher the evaluation priority, regardless of their SL channel type; if multiple SL transmissions have the same transmission priority and are carried by different types of SL channels, the UE determines that an SL transmission carried by an PSFCH (a PSFCH for HARQ feedback or PSFCH for resource conflict indicator) always has a higher evaluation priority than that of an SL transmission carried by a PSSCH. Accordingly, in this example, the UE determines an evaluation priority order from highest to lowest is PSFCH #2>PSSCH #1>PSFCH #1>PSSCH #2>PSSCH #4>PSSCH #3>PSSCH #5.

In operation 220, the UE evaluates at least one of the first set of SL transmissions following the aforementioned order (from highest to lowest) to determine whether to add the at least one SL transmission to a second set of SL transmissions. Before perform operation 220, the second set of SL transmissions is null, a total transmission power P_{total_portion1} during portion 1 is 0.0, a total transmission power P_{total_portion2} during portion 2 is 0.0; herein the parameters P_{total_portion1} and P_{total_portion2} are introduced for evaluation performed in operation 220, each of them is a total transmission power of the second set of SL transmission and an SL transmission under evaluation during a corresponding portion.

In operation 220, the UE may perform the following steps one by one by referring to flow chart 400:
The UE firstly evaluates PSFCH #2 due to it having the highest evaluation priority. By so far, P_{total_portion1}=0.0P_{CMAX}, and P_{total_portion2}=0.4P_{CMAX}; herein P_{total_portion1} is a total transmission power during portion1, and P_{total_portion2} is a total transmission power during portion2. As P_{total_portion1} and P_{total_portion2} don't exceed P_{CMAX}, the UE determines to add PSFCH #2 to the second set of SL transmissions. By so far, the second set of SL transmissions has one member PSFCH #2. The SL transmissions to be evaluated later are {PSSCH #1, PSFCH #1, PSSCH #2, PSSCH #4, PSSCH #3, PSSCH #5}.
The UE then evaluates PSSCH #1. By so far, P_{total_portion1}=0.2P_{CMAX}; P_{total_portion2}=0.6P_{CMAX}. AS P_{total_portion1} and P_{total_portion2} don't exceed P_{CMAX}, the UE determines to add PSSCH #1 to the second set of SL transmissions. By so far, the second set of SL transmissions has two members: PSFCH #2 and PSSCH #1. The SL transmissions to be evaluated later are {PSFCH #1, PSSCH #2, PSSCH #4, PSSCH #3, PSSCH #5}.
The UE then evaluates PSFCH #1. By so far, P_{total_portion1}=0.2P_{CMAX} and P_{total_portion2}=1.0P_{CMAX}. As P_{total_portion1} and P_{total_portion2} don't exceed P_{CMAX}, the UE adds PSFCH #1 to the second set of SL transmissions. By so far, the second set of SL transmissions has three members: PSFCH #2, PSSCH #1, and PSFCH #1. The SL transmissions to be evaluated later are {PSSCH #2, PSSCH #4, PSSCH #3, PSSCH #5}.
The UE then evaluates PSSCH #2. By so far, P_{total_portion1}=0.4P_{CMAX} and P_{total_portion2}=1.2P_{CMAX}. The total transmission power P_{total_portion2} for portion 2 exceeds P_{CMAX}. Since PSSCH #2 is carried by a PSSCH, the UE tries to adjust the transmission power of PSSCH #2. However, in this example, the total transmission power of portion 2 still exceeds P_{CMAX} unless the transmission power of PSSCH #2 is zero. Therefore, the UE determines not to add PSSCH #2 to the second set of SL transmissions, and stop evaluating any SL transmission occupying at least portion2. Accordingly, the UE will not evaluate PSSCH #3; i.e., the UE will drop PSSCH #3 for transmission. By so far, the second set of SL transmissions still has three members: PSFCH #2, PSSCH #1, and PSFCH #1; the SL transmissions to be evaluated later are {PSSCH #4, PSSCH #5} that occupying only portion1.
The UE continues to evaluate PSSCH #4. By so far, P_{total_portion1}=0.8P_{CMAX} which doesn't exceed the maximum transmission power; therefore, the UE determines to add PSSCH #4 to the second set of SL transmissions. The SL transmission to be evaluated is {PSSCH #5}.
The UE continues to evaluate PSSCH #5. Currently, P_{total_portion1}=0.9P_{CMAX} which doesn't exceed the maximum transmission power; therefore, the UE determines to add PSSCH #5 to the second set of SL transmissions.

Finally, in operation 220, the second set of SL transmissions is {PSSCH #1, PSSCHS4, PSSCH #5, PSFCH #1, PSFCH #2}; the UE drops PSSCH #2, and PSSCH #3 for transmission, i.e., the UE does not transmit PSSCH #2, and PSSCH #3.

In operation 230, the UE transmits the second set of SL transmissions {PSSCH #1, PSSCH$4, PSSCH #5, PSFCH #1, PSFCH #2}, P_{total_portion1}=0.9P_{CMAX} and P_{total_portion2}=P_{CMAX}.

In some cases, a UE may receive PSSCH(s) from other UEs; accordingly, it may transmit associated PSFCH(s) later. As the UE cannot predict accurately when to perform a PSSCH reception, the transmission of an associated PSFCH is also cannot be planned in advance; it may cause negative effect on transmission power control. Therefore, it needs to take some special operations to implementing restriction of the maximum transmission power.

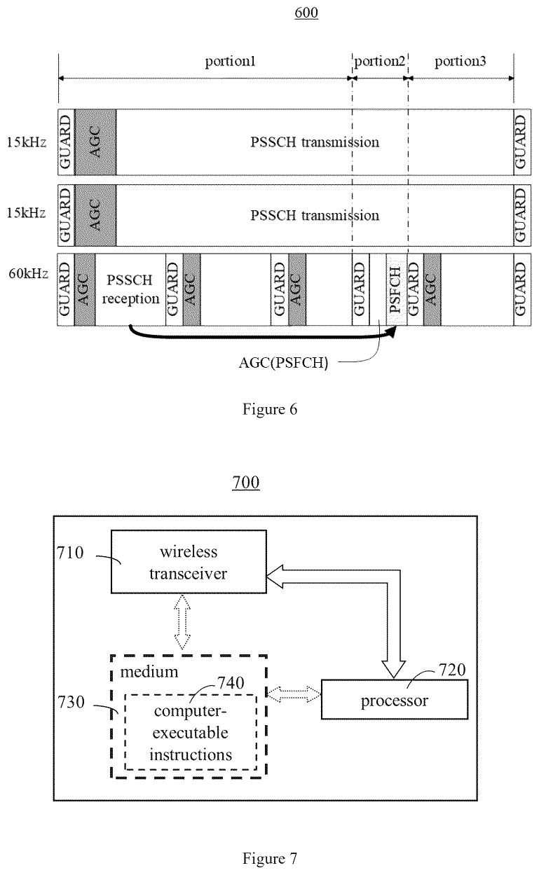

FIG. 6 illustrates an example where an UE receive an unpredicted PSSCH in an occasion 600. In occasion 600, there are 3 CCs, one of them has a subcarrier spacing 60 kHz (SCSₘₐₓ), and other two have a subcarrier spacing 15 kHz (SCSₘᵢₙ),

$$\frac{{SCS}_{min}}{{SCS}_{max}} = 1 / 4.$$

Occasion 600 is a SL slot of 1 ms depending on the subcarrier spacing of 15 kHz. Occasion 600 is divided into 3 portions (portion1, portion2, and portion3) depending upon the transmission power varying.

In portion 1, the UE receives an unpredicted PSSCH; accordingly, the UE needs to transmit a PSFCH in portion2 which is associated with the received PSSCH.

If the transmission of the PSFCH in portion2 will not result in total transmission power in portion2 being greater than the maximum transmission power, the UE will transmit this PSFCH in portion2.

If the transmission of the PSFCH will result in total transmission power in portion2 being greater than the maximum transmission power, the UE will drop this PSFCH in portion2; i.e., the UE will not transmit the PSFCH in portion2 which is associated with the PSSCH reception in portion1.

According to some embodiments of the present disclosure, evaluation priority and portions depended upon transmission power varying are introduced for implementing transmission power limitation. This may reduce power wasting and drop less SL transmissions compared with legacy solutions used in NR SL CA.

According to some embodiments of the present disclosure, various methods are provided for implementing maximum transmission power limitation in the cases that different types of SL channels and different subcarrier spacings are used, and/or multiple SL transmission may partly overlap with each other.

According to some embodiments of the present disclosure, the SL channel types may be PSSCH, PSFCH for HARQ feedback, PSFCH for resource conflict indicator. However, it is contemplated that more types of SL channels may be support with the technical development in the further.

According to some embodiments of the present disclosure, even if the UE cannot predict the total transmission power accurately in some cases, the UE may still control the total transmission power under the restrict of the maximum transmission power.

The aforementioned various methods are based on that the higher the transmission priority value, the lower the transmission priority. It is contemplated that the technical solution is also suitable for the cases that the higher the transmission priority value, the higher the transmission priority.

FIG. 7 illustrates a simplified block diagram of an exemplary apparatus 700 according to some embodiments of the present disclosure. In some embodiments, apparatus 700 may be or include at least a part of an SL UE or similar device that can use the technology of the present disclosure.

As shown in FIG. 7, apparatus 700 may include at least wireless transceiver 710 and processor 720, wherein wireless transceiver 710 may be coupled to processor 720. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, wireless transceiver 710, non-transitory computer-readable medium 730, and processor 720 may be coupled to each other via one or more local buses.

Although in FIG. 7, elements such as wireless transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In some embodiments, processor 720 is configured to cause the apparatus 700 at least to perform, with wireless transceiver 710, any method (e.g., method 200) described above which is performed by a UE according to some embodiments of the present disclosure.

In some embodiments, processor 720 is configured to: in response to that total SL transmission power of a first set of SL transmissions is above a maximum transmission power: determine evaluation priorities for the first set of SL transmissions; evaluate at least one SL transmission of the first set of SL transmissions in order according to the determined evaluation priorities and the maximum transmission power to determine whether to add the at least one SL transmission to a second set of SL transmissions; and transmit, with the wireless transceiver, the second set of SL transmissions, herein the second set of SL transmissions can be performed on sub-carriers with different subcarrier spacings.

In some embodiments, processor 720 is further configured to divide an occasion into several portions according to the transmission power varying.

In some embodiments, the determination of the evaluation priorities for the first set of SL transmissions is performed based partly on at least one of the following: a transmission priority, an SL channel type, or transmission power associated with each SL transmission of the first set of SL transmissions. In some cases, transmission power and/or occupied duration may be taken into consider.

In some embodiments, an SL channel type for each SL transmission of the first set of SL transmissions is PSFCH for HARQ feedback, PSSCH, or PSFCH for resource conflict indicator. According to some embodiments of the present disclosure, some other types of SL channels may be supported with the technology development.

In some embodiments, processor 720 determines that, within the first set of SL transmissions, an evaluation priority of an SL transmission having a higher transmission priority is higher than that of another SL transmission having a lower transmission priority, regardless of the SL channel types. In some cases, there may be two SL transmissions of the first set of SL transmissions that are carried by different types of SL channels and have the same transmission priority, processor 720 determines their evaluation priorities further according to their SL channel types: in some embodiments, processor 720 determines that one SL transmission carried by the PSFCH for HARQ feedback has a higher evaluation priority than that of the other SL transmission having the same transmission priority and carried by the PSSCH; in some embodiments, processor 720 determines that one SL transmission carried by the PSSCH has a higher evaluation priority than that of the other SL transmission having the same transmission priority and carried by the PSFCH for resource conflict indicator; in some embodiments, processor 720 determines that one SL transmission carried by the PSSCH has a higher evaluation priority than that of the other SL transmission having the same transmission priority and carried by the PSFCH for resource conflict indicator; and in some embodiments, if one of these two SL transmissions is carried by a PSFCH for HARQ feedback or PSFCH for resource conflict indicator, the other is carried by a PSSCH, processor 720 determines that the SL transmission carried by the PSSCH has a lower evaluation priority.

In some embodiments, processor 720 takes the SL channel type of each SL transmission of the first set of SL transmissions into consider when determining the evaluation priorities of the first set of SL transmissions. In some embodiments, processor 720 determines that an evaluation priority of an SL transmission carried by a PSFCH for HARQ feedback is always higher than that of an SL transmission carried by a PSSCH, regardless of their transmission priorities. In some embodiments, processor 720 determines that an evaluation priority of an SL transmission carried by a PSSCH is always higher than that of an SL transmission carried by a PSFCH for resource conflict indicator, regardless of their transmission priorities. In some embodiments, processor 720 determines that an evaluation priority of an SL transmission which has a higher transmission priority and is carried by a PSSCH or a PSFCH for resource conflict indicator is always higher than that of an SL transmission which has a lower transmission priority and is carried by a PSSCH or a PSFCH for resource conflict indicator. In some embodiments, processor 720 determines that an SL transmission carried by a PSFCH either for resource conflict indicator or for HARQ feedback always has a higher evaluation priority as that of an SL transmission carried by a PSSCH, regardless of their transmission priorities. In some embodiments, there may be two SL transmissions carried by the same type of channels respectively, processor 720 determines one SL transmission having a higher transmission priority has a higher evaluation priority than that of the other SL transmission having a lower transmission priority.

In some cases, there are two SL transmissions carried by the same type of SL channels and have the same transmission priority. In some embodiments, if both of these two SL transmissions are carried by PSSCHs, processor 720 determines the one occupying fewer portions, or shorter duration, or with less transmission power has a higher evaluation priority. In some embodiments, if both of these two SL transmissions are carried by PSFCHs for HARQ, processor 720 determines the one with less transmission power has a higher evaluation priority.

In some embodiments, after determination of the evaluation priorities for the first set of SL transmissions, processor 720 evaluates at least one SL transmission of the first set of SL transmissions according to the evaluation priorities (from highest to lowest) to determine whether to add the at least one transmission to a second set of SL transmissions for performing transmission; before the evaluation of the at least one SL transmissions, the second set of SL transmissions is null. In some embodiments, if total transmission power of the selected SL transmission and the second set of SL transmissions is less than or equal to the maximum transmission power within an occasion, processor 720 adds the selected SL transmission to the second set of SL transmissions. In some embodiments, if a total transmission power of the selected SL transmission and the second set of SL transmissions is greater than the maximum transmission power within at least one portion of an occasion and the SL channel carrying the selected SL transmission is not a PSSCH, processor 720 drops the selected SL transmission, stops the evaluation associated with the maximum transmission power on the at least one portion. In some embodiments, if a total transmission power of the selected SL transmission and the second set of SL transmissions is greater than the maximum transmission power within at least one portion of an occasion, and the SL channel carrying the selected SL transmission is a PSSCH, processor 720 adjusts the transmission power of the selected SL transmission; if total transmission power of the adjusted transmission power of the selected SL transmission and transmission power of the second set of SL transmissions is less than or equates to the maximum transmission power within the at least one portion, processor 720 adds the selected SL transmission to the second set of SL transmissions; if the total transmission power is still greater than the maximum transmission power within the at least one portion, processor 720 drops the selected SL transmission, drops any SL transmissions (partly) occupying the at least one portion and yet not be evaluated, and stops the evaluation associated with the at least one portion.

In some embodiments, after processor 720 processes (adds to the second set of SL transmissions or drops) all the SL transmissions of the first set of SL transmissions, if the second set of SL transmissions includes at least one SL transmission, the UE transmits the second set of SL transmissions.

In various example embodiments, the processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 720 may also include at least one other circuitry or element not shown in FIG. 7.

In various example embodiments, the non-transitory computer-readable medium 730 may include at least one storage medium in various forms, such as a volatile memory and/or a non-volatile memory. The volatile memory may include, but is not limited to, for example, a RAM, a cache, and so on. The non-volatile memory may include, but is not limited to, for example, a ROM, a hard disk, a flash memory, and so on. Further, the non-transitory computer-readable medium 730 may include, but is not limited to, an electric, a magnetic, an optical, an electromagnetic, an infrared, or a semiconductor system, apparatus, or device or any combination of the above.

Further, in various example embodiments, the apparatus 700 may also include at least one other circuitry, element, and interface, for example antenna element, and the like.

In various example embodiments, the circuitries, parts, elements, and interfaces in the apparatus 700 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to, in response to total SL transmission power of a first set of sidelink (SL) transmissions being above a maximum transmission power, cause the UE to:
determine evaluation priorities for the first set of SL transmissions;
evaluate at least one SL transmission of the first set of SL transmissions in order according to the determined evaluation priorities and the maximum transmission power to determine whether to add the at least one SL transmission to a second set of SL transmissions; and
transmit the second set of SL transmissions, wherein the second set of SL transmissions can be performed on subcarriers with different subcarrier spacings.

2. The UE of claim 1, wherein the at least one processor is further configured to cause the UE to determine the evaluation priorities for the first set of SL transmissions based partly on at least one of: a transmission priority, an SL channel type, or transmission power associated with each SL transmission of the first set of SL transmissions.

3. The UE of claim 2, wherein an SL channel type for each SL transmission of the first set of SL transmissions is physical SL feedback channel (PSFCH) for hybrid automatic repeat request (HARQ) feedback, physical SL shared channel (PSSCH), or PSFCH for resource conflict indicator.

4. The UE of claim 3, wherein to determine the evaluation priorities, the at least one processor is further configured to cause the UE to determine that, among the first set of SL transmissions, an evaluation priority of an SL transmission having a higher transmission priority is higher than that of another SL transmission having a lower transmission priority.

5. The UE of claim 4, wherein to determine the evaluation priorities, in response to both a first SL transmission of the first set of SL transmissions carried by a PSFCH for HARQ feedback and a second SL transmission of the first set of SL transmissions carried by a PSSCH having a same transmission priority, the at least one processor is further configured to cause the UE to determine that an evaluation priority of the first SL transmission is higher than that of the second SL transmission.

6. The UE of claim 3, wherein the at least one processor is further configured to cause the UE to determine the evaluation priorities of the first set of SL transmissions based on at least the SL channel type of each SL transmission of the first set of SL transmissions.

7. The UE of claim 6, wherein the at least one processor is further configured to cause the UE to determine that among the first set of SL transmissions, an evaluation priority of a first SL transmission carried by a PSFCH for HARQ feedback is higher than that of a second SL transmission carried by a PSSCH.

8. The UE of claim 3, wherein to determine the evaluation priorities, in response to both a first SL transmission of the first set of SL transmissions and a second SL transmission of the first set of SL transmissions having a same transmission priority and are carried by PSSCHs, and the first SL transmission occupies a shorter duration than that of the second SL transmission, the at least one processor is further configured to cause the UE to determine that an evaluation priority of the first SL transmission is higher than that of the second SL transmission.

9. The UE of claim 3, wherein to determine the evaluation priorities, in response to both a first SL transmission of the first set of SL transmissions and a second SL transmission of the first set of SL transmissions having a same transmission priority and are carried by PSSCHs, and the first SL transmission has less transmission power that that of the second SL transmission, the at least one processor is further configured to cause the UE to determine that the first SL transmission has a higher evaluation priority than that of the second SL transmission.

10. The UE of claim 3, wherein to determine the evaluation priorities, in response to both a first SL transmission of the first set of SL transmissions and a second SL transmission of the first set of SL transmissions having a same transmission priority and are carried by PSFCHs for HARQ feedback, and the first SL transmission has less transmission power that that of the second SL transmission, the at least one processor is further configured to cause the UE to determine that the first SL transmission has a higher evaluation priority than that of the second SL transmission.

11. The UE of claim 1, wherein to evaluate at least one SL transmission of the first set of SL transmissions in order, the at least one processor is further configured to cause the UE to:
select an SL transmission among the first set of SL transmissions in order according to the determined evaluation priorities of the first set of SL transmissions; and
in response to total transmission power of the selected SL transmission and the second set of SL transmissions being less than or equal to the maximum transmission power, add the selected SL transmission to the second set of SL transmissions.

12. The UE of claim 11, wherein in response to total transmission power of the selected SL transmission and the second set of SL transmissions being greater than the maximum transmission power and the selected SL transmission is carried by an SL channel other than a PSSCH, the at least one processor is further configured to cause the UE to:
stop the evaluation associated with the maximum transmission power.

13. The UE of claim 11, wherein in response to total transmission power of the selected SL transmission and the second set of SL transmissions being greater than the maximum transmission power and the selected SL transmission is carried by a PSSCH, the at least one processor is further configured to cause the UE to:
adjust transmission power of the selected SL transmission; and
in response to total transmission power of the adjusted transmission power of the selected SL transmission and transmission power of the second set of SL transmissions being less than or equates to the maximum transmission power, add the selected SL transmission to the second set of SL transmissions.

14. The UE of claim 13, wherein in response to total transmission power of the adjusted transmission power of the selected SL transmission and the transmission power of the second set of SL transmissions being greater than the maximum transmission power, the at least one processor is further configured to cause the UE to:
stop the evaluation associated with the maximum transmission power.

15. A method performed by a user equipment (UE), the method comprising:
in response to total SL transmission power of a first set of sidelink (SL) transmissions being above a maximum transmission power:
determining evaluation priorities for the first set of SL transmissions;
evaluating at least one SL transmission of the first set of SL transmissions in order according to the determined evaluation priorities and the maximum transmission power, so as to determine whether to add the at least one SL transmission to a second set of SL transmissions; and
transmitting the second set of SL transmissions, wherein the second set of SL transmissions can be performed on subcarriers with different subcarrier spacings.

16. A processor for wireless communication, comprising:
at least one controller coupled with at least one memory and configured to, in response to total SL transmission power of a first set of sidelink (SL) transmissions being above a maximum transmission power, cause the processor to:
determine evaluation priorities for the first set of SL transmissions;
evaluate at least one SL transmission of the first set of SL transmissions in order according to the determined evaluation priorities and the maximum transmission power to determine whether to add the at least one SL transmission to a second set of SL transmissions; and
transmit the second set of SL transmissions, wherein the second set of SL transmissions can be performed on subcarriers with different subcarrier spacings.

17. The processor of claim 16, wherein the at least one controller is further configured to cause the processor to determine the evaluation priorities for the first set of SL transmissions based partly on at least one of: a transmission priority, an SL channel type, or transmission power associated with each SL transmission of the first set of SL transmissions.

18. The processor of claim 17, wherein an SL channel type for each SL transmission of the first set of SL transmissions is physical SL feedback channel (PSFCH) for hybrid automatic repeat request (HARQ) feedback, physical SL shared channel (PSSCH), or PSFCH for resource conflict indicator.

19. The processor of claim 18, wherein the at least one controller is further configured to cause the processor to determine the evaluation priorities of the first set of SL transmissions based on at least the SL channel type of each SL transmission of the first set of SL transmissions.

20. The processor of claim 16, wherein to evaluate at least one SL transmission of the first set of SL transmissions in order, the at least one controller is further configured to cause the processor to:
select an SL transmission among the first set of SL transmissions in order according to the determined evaluation priorities of the first set of SL transmissions; and
in response to total transmission power of the selected SL transmission and the second set of SL transmissions being less than or equal to the maximum transmission power, add the selected SL transmission to the second set of SL transmissions.
